(19) United States
(12) Patent Application Publication
(10) Pub. No.: US 2025/0254409 A1
(43) Pub. Date: Aug. 7, 2025

(54) LENS APPARATUS AND IMAGING SYSTEM

(71) Applicant: CANON KABUSHIKI KAISHA, Tokyo (JP)

(72) Inventor: KENTA TAKAI, Kanagawa (JP)

(21) Appl. No.: 19/027,879

(22) Filed: Jan. 17, 2025

(30) Foreign Application Priority Data
Feb. 7, 2024 (JP) 2024-016999

(51) Int. Cl. H04N 23/55

(52) U.S. Cl. CPC H04N 23/55

(57) ABSTRACT

A lens apparatus includes a lens mount attachable to and detachable from an image pickup apparatus having a first bayonet claw and a first terminal portion. The lens mount includes a second bayonet claw portion engageable with the first bayonet claw of the image pickup apparatus, a second terminal portion that contacts the first terminal portion of the image pickup apparatus in a case where the lens apparatus is attached to the image pickup apparatus, and a bayonet groove portion configured to detachably attach an optical element unit. The bayonet groove portion and the second terminal portion are disposed on a predetermined circumference with an optical axis of the lens apparatus as a center.

### BACKGROUND

### Technical Field

The disclosure relates to a lens apparatus and an imaging system.

### Description of Related Art

It is effective for a large-diameter lens apparatus to enlarge an opening in a lens mount so as not to degrade the optical performance. A lens apparatus that includes a mechanism configured to hold an optical filter (optical element) provided in a lens mount so that the user can attach an arbitrary optical filter.

Japanese Patent Laid-Open No. 2020-67575 discloses a structure having a lock mechanism configured to detachably hold a filter in the lens mount. Japanese Patent Laid-Open No. 2019-105704 discloses a structure configured to attach a filter to a lens apparatus via a holding frame.

In the structure disclosed in Japanese Patent Laid-Open No. 2020-67575, the filter is disposed on the object side of the bayonet portion, and the back focus is to be increased so that the filter and the lens closest to the image plane do not interfere with each other, which becomes a constraint on the optical design and optical performance. Since the filter holding mechanism is disposed on the inner diameter side of the lens mount, the opening in the lens mount becomes narrow, and it becomes difficult to achieve a bright and large-diameter lens apparatus. Since the holding mechanism cannot be retracted even in a case where the filter is not in use, incident light may be reflected or diffused by the holding mechanism, and unwanted light can enter the imaging surface.

In the structure disclosed in Japanese Patent Laid-Open No. 2019-105704, while the magnetic adhesion force which the user can easily attach and detach the filter may not maintain the filter holding frame due to vibration or impact, and dust may enter the camera mount, damaging the shutter or image sensor.

### SUMMARY

A lens apparatus according to one aspect of the disclosure includes a lens mount attachable to and detachable from an image pickup apparatus having a first bayonet claw and a first terminal portion. The lens mount includes a second bayonet claw portion engageable with the first bayonet claw of the image pickup apparatus, a second terminal portion that contacts the first terminal portion of the image pickup apparatus in a case where the lens apparatus is attached to the image pickup apparatus, and a bayonet groove portion configured to detachably attach an optical element unit. The bayonet groove portion and the second terminal portion are disposed on a predetermined circumference with an optical axis of the lens apparatus as a center. An imaging system having the above lens apparatus also constitutes another aspect of the disclosure.

Further features of various embodiments of the disclosure will become apparent from the following description of embodiments with reference to the attached drawings.

### BRIEF DESCRIPTION OF THE DRAWINGS

FIGS. 1A and 1B are perspective views of an imaging system according to each embodiment.

FIG. 2 is a block diagram of the imaging system according to each embodiment.

FIG. 3 is a sectional view of an interchangeable lens according to each embodiment.

FIG. 4 is a front view of a camera body according to each embodiment.

FIG. 5 is a perspective view of an interchangeable lens according to each embodiment.

FIGS. 6A and 6B are a rear view and a sectional view of a lens mount according to a first embodiment.

FIGS. 7A and 7B are a rear view and a rear oblique view of the lens mount according to the first embodiment.

FIGS. 8A and 8B are a rear oblique view and an exploded oblique view of an optical element unit according to the first embodiment.

FIGS. 9A and 9B are a rear view and a sectional view of a lens mount according to a second embodiment.

FIGS. 10A and 10B are a rear view and a rear oblique view of the lens mount according to the second embodiment.

### DETAILED DESCRIPTION

Referring now to the accompanying drawings, a detailed description will be given of embodiments according to the disclosure. Corresponding elements in respective figures will be designated by the same reference numerals. This embodiment will discuss an interchangeable lens, which is an example of a lens apparatus, but various modifications and changes can be made to this disclosure within the scope of its gist.

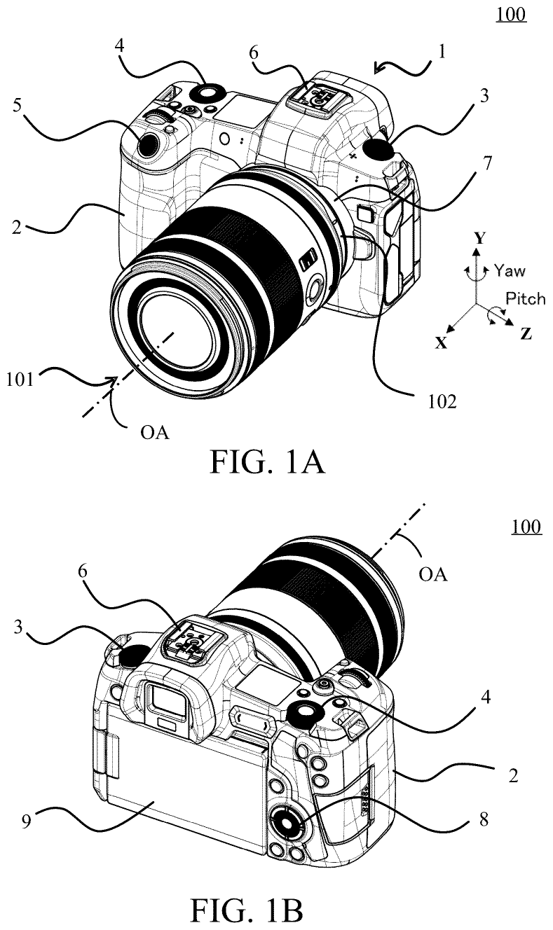

Referring now to FIGS. 1A and 1B, a description will now be given of the external configuration of an imaging system 100 according to each embodiment. FIGS. 1A and 1B are external views of the imaging system 100. FIG. 1A is a perspective view of the imaging system 100 viewed from the front side, and FIG. 1B is a perspective view of the imaging system 100 viewed from the rear side. The imaging system 100 includes a camera body (image pickup apparatus such as a digital camera) 1 and an interchangeable lens (lens apparatus) 101 that is attachable to and detachable from the camera body 1.

As illustrated in FIG. 1A, a direction in which an optical axis OA of the imaging optical system of the interchangeable lens 101 extends (optical axis direction) is defined as an X-axis direction, and directions orthogonal to the optical axis direction are defined as a Z-axis direction (horizontal direction) and a Y-axis direction (vertical direction). Hereinafter, the Z-axis direction and the Y-axis direction will be collectively referred to as a Z/Y-axis direction. A rotation direction around the Z-axis is a pitch direction, and a rotation direction around the Y-axis is a yaw direction. The pitch direction and yaw direction (collectively referred to as a pitch/yaw direction hereinafter) are rotation directions around two mutually orthogonal axes, the Z-axis and the Y-axis.

A grip portion 2 is used for a user to hold the camera body 1 with his/her hand and is provided on the left side of the camera body 1 when viewed from the front (object side) (right side when the camera body 1 is viewed from the back). A power operation unit 3 is provided on the top surface of the camera body 1. In a case where the user turns on the power operation unit 3 while the camera body 1 is in the power-off state, the camera body 1 is turned on and imaging is possible. In a case where the user turns off the power operation unit 3 while the camera body 1 is in the power-on state, the camera body 1 is turned off.

A mode dial 4, a release button 5, and an accessory shoe 6 are provided on the top surface of the camera body 1. The user can switch the imaging mode by rotating the mode dial 4. The imaging modes include a manual still image capturing mode in which the user can set an imaging condition such as a shutter speed and an aperture value (F-number), an auto still image capturing mode in which the proper exposure amount is automatically obtained, and a moving image capturing mode for capturing a moving image. The user can instruct an imaging preparation operation such as autofocus (AF) and auto-exposure (AE) control by half-pressing the release button 5, and can instruct imaging by fully pressing the button. Accessories such as an external flash are attachable to and detachable from the accessory shoe 6. The camera body 1 includes an image sensor that photoelectrically converts (captures) an object image (optical image) formed by the imaging optical system in the interchangeable lens 101.

The interchangeable lens 101 includes a lens mount 102 attachable to and detachable from the camera body 1. The interchangeable lens 101 is mechanically and electrically connected to a camera mount 7 provided on the camera body 1 via the lens mount 102. As described above, the interchangeable lens 101 has an imaging optical system that forms an object image by focusing light from an object.

As illustrated in FIG. 1B, a rear operation unit 8 and a display unit 9 are provided on the rear surface of the camera body 1. The rear operation unit 8 includes a number of buttons and dials to which various functions are assigned. In a case where the camera body 1 is powered on and a still or moving image mode is set, the display unit 9 displays a through-image of the object image captured by the image sensor. The display unit 9 also displays imaging parameters indicating imaging conditions such as a shutter speed and an aperture value (F-number). The user can change a set value of the imaging parameter by operating the rear operation unit 8 while viewing the display. The rear operation unit 8 includes a playback button for instructing playback of a recorded captured image, and the captured image is played back and displayed on the display unit 9 in a case where the user operates the playback button.

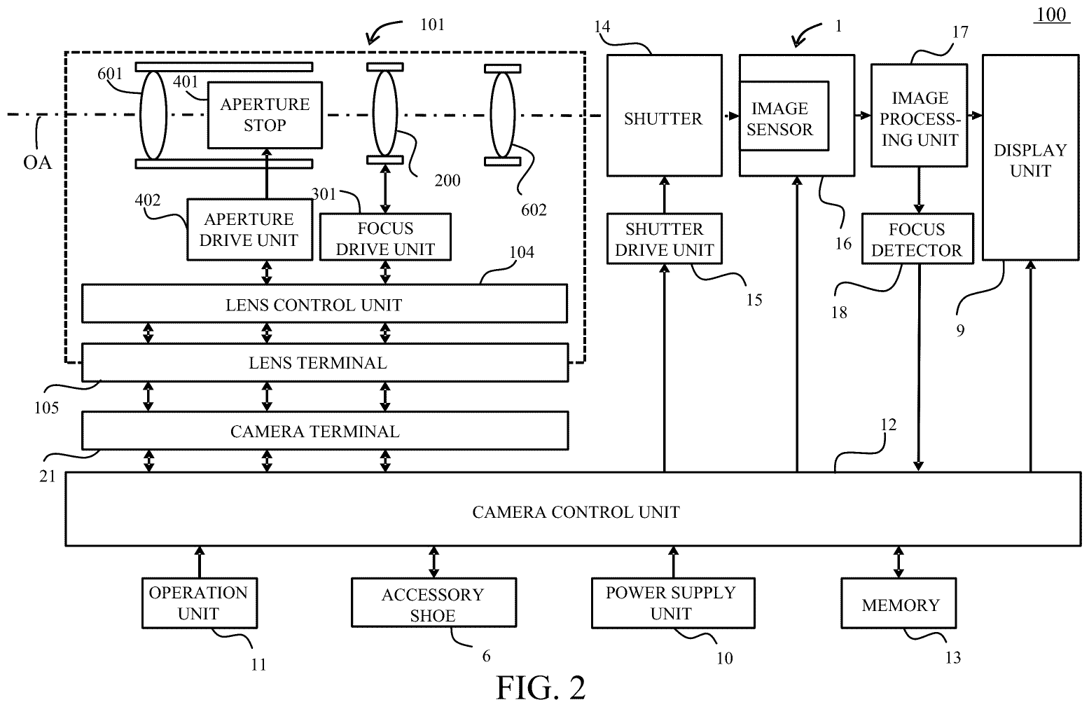

Referring now to FIG. 2, a description will be given of the internal configuration of the imaging system 100. FIG. 2 is a block diagram illustrating the electrical and optical configuration of the imaging system 100. The camera body 1 includes a power supply unit 10 that supplies power to the camera body 1 and the interchangeable lens 101, and an operation unit 11 including the power operation unit 3, the mode dial 4, a release button 5, the rear operation unit 8, a touch panel function of the display unit 9. The camera body 1 and interchangeable lens 101 are controlled as an entire system by a camera control unit 12 provided in the camera body 1 and a lens control unit 104 provided in the interchangeable lens 101 in cooperation with each other.

The camera control unit 12 reads out and executes a computer program stored in a memory 13. At that time, the camera control unit 12 communicates various control signals, data, etc. with the lens control unit 104 via electrical contacts between camera terminals 21 provided in the camera mount 7 and lens terminal portions 105 provided in the lens mount 102. The camera terminals 21 and the lens terminal portions 105 include a power terminal that supplies power from the power supply unit 10 described above to the interchangeable lens 101.

The imaging optical system in the interchangeable lens 101 includes a focus unit 200 (first focus unit 201, second focus unit 202) that includes a focus lens that moves in the optical axis direction for focusing, and an aperture (stop) unit 401 that adjusts a light amount. The interchangeable lens 101 further includes a focus drive unit 301 that drives the focus unit 200, and an aperture drive unit 402 that drives the aperture unit 401.

The camera body 1 has a shutter unit 14, a shutter drive unit 15, an image sensor 16, an image processing unit 17, and the camera control unit 12 described above. The shutter unit 14 controls a light amount condensed by the imaging optical system in the interchangeable lens 101 and exposed by the image sensor 16. The image sensor 16 photoelectrically converts an object image formed by the imaging optical system and outputs an imaging signal. The image processing unit 17 performs various image processing for the imaging signal and then generates an image signal. The display unit 9 displays the image signal (through-image) and imaging parameters output from the image processing unit 17, and also plays back and displays the captured image recorded in the memory 13 or a recording medium (not illustrated).

The camera control unit 12 controls the driving of the focus unit 200 according to an imaging preparation operation (half-pressing the release button 5) on the operation unit 11. For example, in a case where an AF operation is instructed, a focus detector 18 determines a focus state of an object image formed by the image sensor 16 based on the image signal generated by the image processing unit 17, generates a focus signal, and transmits it to the camera control unit 12. At the same time, the focus drive unit 301 detects the current position of the focus unit 200 and transmits the detection signal to the camera control unit 12 via the lens control unit 104. The camera control unit 12 compares the focus state of the object image with the current position of the focus unit 200, calculates a focus drive amount based on a shift amount that is the comparison result, and transmits it to the lens control unit 104. Then, the lens control unit 104 drives and controls the focus unit 200 to the target position via the focus drive unit 301, and corrects the focus shift of the object image.

The focus drive unit 301 includes a focus motor that functions as an actuator, and a position detector that detects the position of the focus unit 200. In general, a stepping motor, an ultrasonic motor, or a voice coil motor, which are types of actuators, are often used as the focus motor. A DC motor, a servo motor, or an ultrasonic motor equipped with an encoder may also be used.

The camera control unit 12 controls the driving of the aperture unit 401 and the shutter unit 14 via the aperture drive unit 402 and the shutter drive unit 15 in accordance with the aperture value or shutter speed set value received from the operation unit 11. For example, in a case where an AE control operation is instructed, the camera control unit 12 receives a luminance signal generated by the image processing unit 17 and performs a photometric calculation. Based on the photometric calculation result, the camera control unit 12 controls the driving of the aperture unit 401 in accordance with an imaging instruction operation (full-pressing operation of the release button 5) in the operation unit 11. At the same time, the camera control unit 12 controls the driving of the shutter unit 14 via the shutter drive unit 15 and performs exposure processing by the image sensor 16.

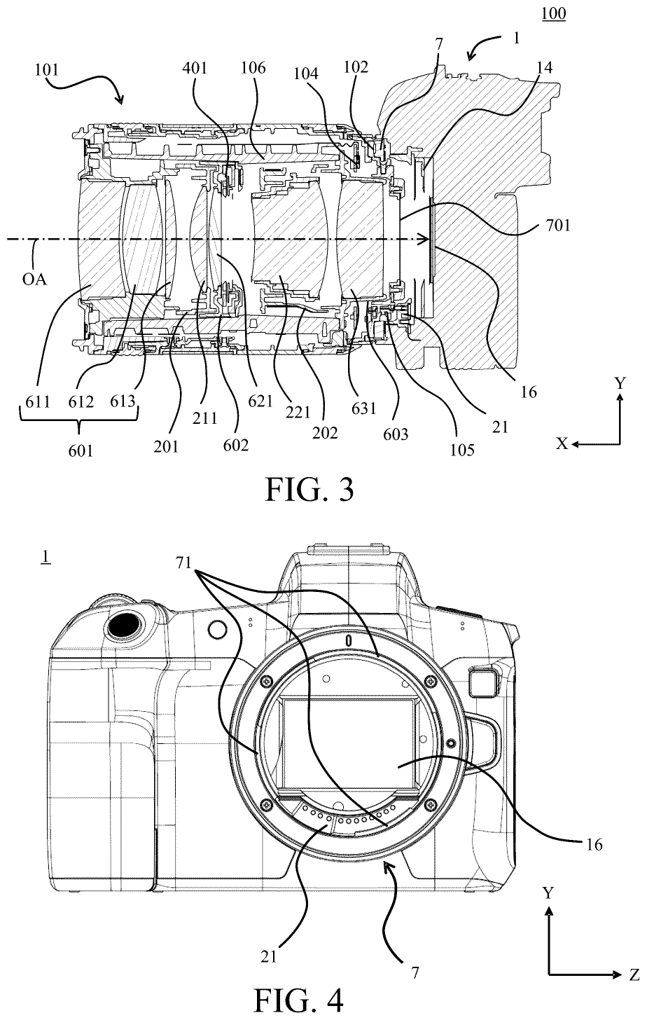

Referring now to FIG. 3, a description will be given of the positional relationship between the interchangeable lens 101 and the components in the camera body 1. FIG. 3 is a sectional view of the imaging system 100 on an XY plane including the optical axis. A centerline illustrated in FIG. 3 substantially coincides with the optical axis OA determined by the imaging optical system, and will be therefore equivalent with the optical axis hereinafter.

In each embodiment, the imaging optical system is a five-unit optical system consisting of, in this order from the object side to the image side, a first fixed unit 601, the first focus unit 201, a second fixed unit 602, the second focus unit 202, and a third fixed unit 603. The first fixed unit 601 includes a first fixed lens 611, a second fixed lens 612, and a third fixed lens 613. The first focus unit 201 includes a first focus lens 211. The second fixed unit 602 includes a fourth fixed lens 621. The second focus unit 202 includes a second focus lens 221. The third fixed unit 603 includes a fifth fixed lens 631.

A fixed barrel 106 holds the first fixed unit 601, the second fixed unit 602, and the third fixed unit 603 on the inner circumference side, and also has the focus drive unit 301 (see FIG. 2) and a linear guide unit (not illustrated) in the optical axis direction. The first focus unit 201 and the second focus unit 202 move to a predetermined optical position according to a focus shift of an object image. Thereby, light from the object is imaged on the imaging surface of the image sensor 16 via the first fixed unit 601, the first focus unit 201, the second fixed unit 602, the second focus unit 202, and the third fixed unit 603.

The aperture unit 401 is housed in the second fixed unit 602 together with the fourth fixed lens 621. The lens mount 102 is fixed to the fixed barrel 106 and connected to the camera mount 7.

An optical element unit 701 is detachably held in the lens mount 102 between the third fixed unit 603 and the image sensor 16. The optical element unit 701 can obtain an arbitrary optical characteristic by transmitting part of the light from the object. The optical element unit 701 has an optical filter such as a soft filter that softens the captured image or a neural density (ND) filter that weakens the intensity of light. However, each embodiment is not limited to this example, and may use another type. Various optical filters can expand a photographic expression method.

The imaging optical system according to each embodiment includes an adjustment mechanism configured to intentionally shift a position of the second focus lens 221 to maintain the optical performance of the imaging optical system as a whole. Thereby, a worker in the assembly process can reduce the influence of manufacturing errors or assembly variations that would occur in each component while checking the state of the overall optical performance.

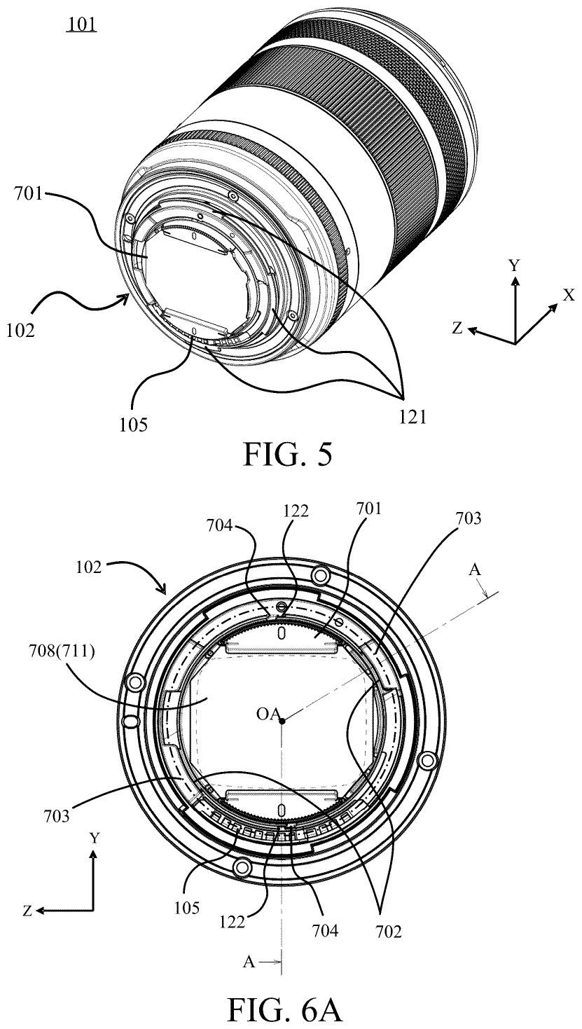

Referring now to FIGS. 4 and 5, a description will be given of a mount unit according to each embodiment. FIG. 4 is a front view of the camera body 1, illustrating the camera mount 7. FIG. 5 is a perspective view of the interchangeable lens 101 viewed from the rear side, illustrating the lens mount 102.

The camera mount 7 includes a plurality of camera bayonet claws (first bayonet claw portions) 71 for mechanical connection with the lens mount 102, and a plurality of camera terminals (first terminal portions) for electrical connection with the lens mount 102. The lens mount 102 includes a plurality of lens bayonet claws (second bayonet claw portions) 21 for mechanical connection with the camera mount 7, and a plurality of lens terminal portions (second terminal portions) 105 for electrical connection with the camera mount 7.

The plurality of lens bayonet claws 121 are engageable with the plurality of camera bayonet claws 71. In attaching the interchangeable lens 101 to the camera body 1, the interchangeable lens 101 is inserted at an angle such that the lens bayonet claws 121 enter the spaces between the camera bayonet claws 71 in the circumferential direction that has a center at the optical axis OA (X-axis). Then, the camera mount 7 and the lens mount 102 are rotated to a desired angle while they contact each other in the optical axis (X-axis) direction. Thereby, the camera bayonet claws 71 and the lens bayonet claws 121 can be engaged with each other and are mechanically connected. The plurality of camera terminals 21 and the plurality of lens terminal portions 105 contact each other and are electrically connected. That is, the plurality of lens terminal portions 105 contact the plurality of camera terminals 21 in a case where the interchangeable lens 101 is attached to the camera body 1. The optical element unit 701 is disposed on the inner diameter of the lens mount 102 and is detachably held by the lens mount 102. Each embodiment will be described in detail below.

### First Embodiment

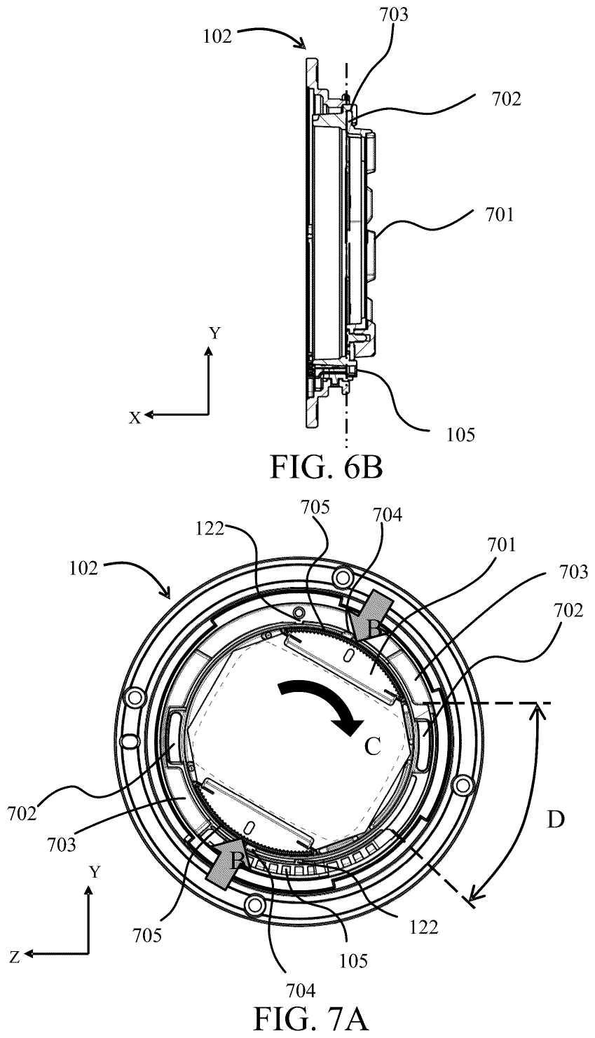

Referring now to FIGS. 6A and 6B, a description will be given of a structure configured to hold the optical element unit 701 on the lens mount 102 according to the first embodiment. FIG. 6A is a rear view of the lens mount 102. FIG. 6B is a sectional view taken along line A-A including the optical axis OA in FIG. 6A. FIGS. 6A and 6B each illustrate an engagement state between the lens mount 102 and the optical element unit 701. The optical element unit 701 has an opening 708 (optical element 711) that transmits light at the center portion, and two optical element bayonet claws (third bayonet claw portions) 702 configured to hold the optical element unit 701 on the outer circumferential portion. The two optical element bayonet claws 702 are provided at positions facing each other across the optical axis OA (positions rotated by 180° about the optical axis OA).

Two bayonet groove portions 703 provided in the lens mount 102 are provided for detachably attaching the optical element unit 701. That is, the optical element unit 701 is detachably attached to the interchangeable lens 101 by engaging the two bayonet groove portions 703 with the two optical element bayonet claws 702.

The position of the optical element unit 701 in the optical axis direction is determined by clamping (holding) the two optical element bayonet claws 702 between the two bayonet groove portions 703. Thus, the two bayonet groove portions 703, like the two optical element bayonet claws 702, are provided at positions facing each other across the optical axis OA (positions rotated by 180° about the optical axis OA). That is, at least two of the plurality of bayonet groove portions 703 are disposed at positions facing each other across the optical axis OA. Thereby, the optical element unit 701 is stably held by the lens mount 102 at positions facing each other across the optical axis OA.

Due to the engagement of the tip of a first protrusion portion 704 provided on the optical element unit 701 with the inner circumferential surface of the lens mount 102, the optical element unit 701 can be positioned with high accuracy relative to the optical axis OA of the interchangeable lens 101. Due to the contact between the side portion of the first protrusion portion 704 and the side portion of a second protrusion portion 122 provided on the lens mount 102, the rotation of the optical element unit 701 around the optical axis relative to the lens mount 102 is restricted. Thereby, the optical element unit 701 is less likely to fall off accidentally due to external forces such as shock or vibration.

A description will now be given of a positional relationship between the lens terminal portions 105 and the optical element bayonet claws 702. When viewed from the rear side, the lens terminal portions 105 are arranged in an arc shape so as to follow the inner diameter side of the lens bayonet claws 121. Thus, the size of the opening in the lens mount 102 can be increased.

On the other hand, in order to increase the size of the opening in the optical element unit 701, the optical element bayonet claws 702 are to be separated from the optical axis OA as far as possible. Thus, the optical element bayonet claws 702 are arranged on a predetermined circumference with (or on the same circumference as) the lens terminal portions 105 with the optical axis OA as a center at a phase in which the optical element bayonet claws 702 do not overlap the lens terminal portions 105 (at different positions in the circumferential direction from the lens terminal portions 105). Thereby, the size of the opening in the optical element unit 701 can be increased.

In this embodiment, the bayonet groove portions 703 and the lens terminal portions 105 are arranged on the predetermined circumference with the optical axis OA as the center. When viewed from a direction orthogonal to the optical axis OA, at least a part of the bayonet groove portions 703 and at least a part of the lens terminal portions 105 may be arranged so as to overlap each other on the predetermined circumference. When viewed from the optical axis direction, the bayonet groove portions 703 and the lens terminal portions 105 may be disposed at different positions on the predetermined circumference.

When viewed from the sectional (XY plane) direction as illustrated in FIG. 6B, the lens terminal portions 105 are disposed at the rear end (−X direction) of the lens mount 102 to be connected to the camera terminals 21. On the other hand, the optical element unit 701 is disposed at the rear end (−X direction) so as to overlap the lens mount 102 in the X direction. Thereby, the fifth fixed lens 631 can be brought closer to the image plane, and the back focus can be reduced.

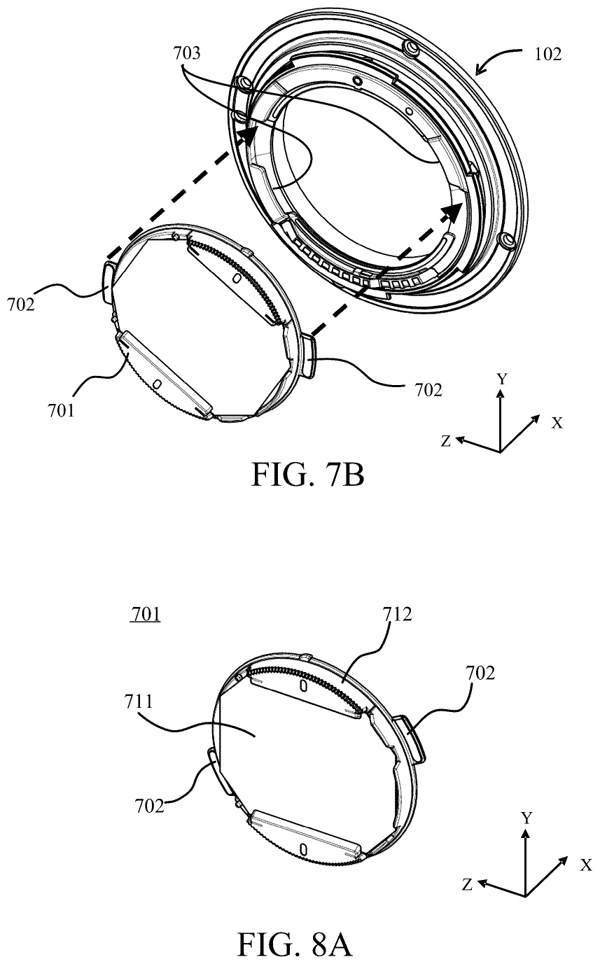

Referring now to FIGS. 7A and 7B, a description will be given of the configuration of the attachment/detachment mechanism of the optical element unit 701. FIG. 7A is a rear view of the lens mount 102. FIG. 7B is a perspective view (rear perspective view) of the lens mount 102. Each of FIGS. 7A and 7B illustrates the optical element unit 701 in a disengagement state.

The optical element unit 701 is provided with an outer circumferential grip portion 705 for gripping during attachment or detachment. The outer circumferential grip portion 705 is located in the same radial direction as the first protrusion portion 704. The outer circumferential grip portion 705 is knurled to prevent slipping when the user's fingers grip it. In detaching the optical element unit 701 from the lens mount 102, the outer circumferential grip portion 705 is gripped by the fingers and the optical element unit 701 is slightly bent in a direction of arrow B in FIG. 7A to separate the contact portion between the side portion of the first protrusion portion 704 and the side portion of the second protrusion portion 122. In this state, the optical element unit 701 is rotated in a direction of arrow C in FIG. 7A for releasing the engagement between the optical element bayonet claws 702 and the bayonet groove portions 703.

An area D in FIG. 7A will now be described. As described above, in attaching and detaching the interchangeable lens 101 to and from the camera body 1, the interchangeable lens 101 is rotated. The area D is an area where the interchangeable lens 101 rotates and the camera terminals 21 enter the lens mount 102 (a first area where the camera terminals 21 move in a case where the interchangeable lens 101 is detached from the camera body 1). The area D is shifted in the +X direction to a height where the lens mount 102 does not contact the tip of the camera terminals 21. Thus, the bayonet groove portions 703 cannot be disposed in the area D.

Accordingly, this embodiment places the bayonet groove portions 703 adjacent to the area D in the circumferential direction, so that the area (second area) where the optical element bayonet claws 702 retract in a case where the optical element unit 701 is attached or detached overlaps the area D (first area). In other words, at least a part of the first area (area D) and at least a part of the second area where the optical element bayonet claws 702 move in a case where the optical element unit 701 is detached from the interchangeable lens 101 are common to each other.

Thereby, the optical element unit 701 can be easily attached or detached, and can be reliably fixed as a result of the attachment. Since the attachment/detachment mechanism can be efficiently disposed, the size of the opening in the lens mount 102 can be increased. Moreover, in a case where the optical element unit 701 is detached, unnecessary light on the imaging surface caused by reflection or diffusion of incident light can be suppressed.

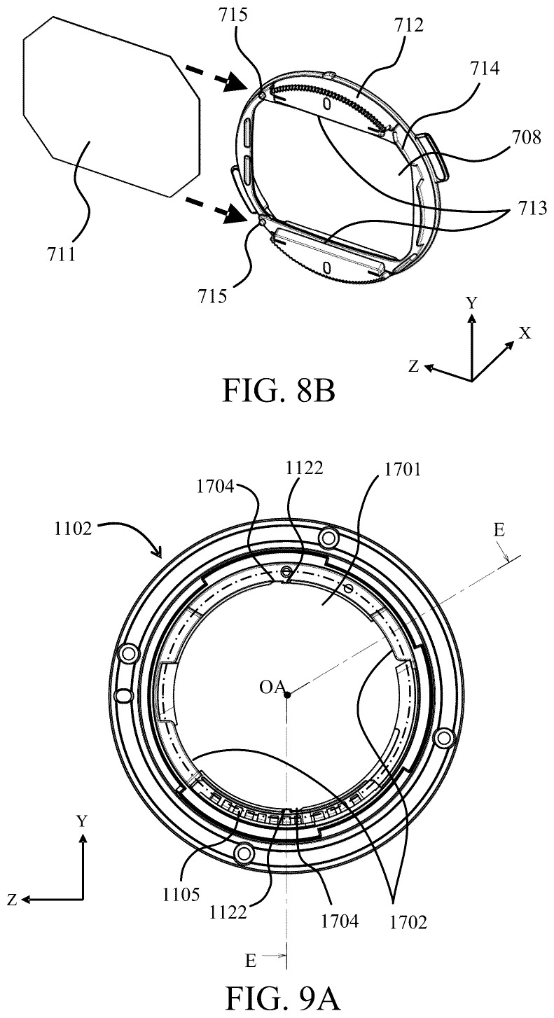

Referring now to FIGS. 8A and 8B, a description will be given of the configuration of the optical element unit 701. FIG. 8A is a rear perspective view of the optical element unit 701. FIG. 8B is an exploded perspective view of the optical element unit 701. FIGS. 8A and 8B each illustrate a holding structure of the optical element 711. The optical element unit 701 includes an optical element 711 that transmits light, and a holding frame (optical element holding frame) 712 that holds the optical element 711 and has the optical element bayonet claws 702 on the outer circumference. The optical element 711 is a sheet-like optical filter, and can be cut into a desired shape by the user. The holding frame 712 includes optical element holders 713 for holding the optical element 711, optical element engagement wall 714, and optical element engagement protrusion portions 715 on the side of the opening. The holding frame 712 holds the optical element 711 outside an effective range of the optical element 711 through which a light ray passes.

The optical element holder 713 has a slit shape that holds the end of the optical element 711, and enables the optical element 711 to be inserted from the Z direction. In this embodiment, the shape and configuration of the optical element holder 713 are not limited to this example as long as it can hold the optical element 711, and a claw member or a cover member, etc., may be used.

The optical element engagement wall 714 and the optical element engagement protrusion portions 715 prevent the optical element 711 inserted from the Z direction from jumping out to the outside of the lens mount 102. The optical element engagement protrusion portions 715 are arranged side by side in the Z direction on the side where the optical element 711 is inserted relative to the optical element holder 713. Therefore, in inserting the optical element 711, the optical element 711 can be attached without damaging the effective range of the optical element 711 through which a light ray passes.

Thereby, the user can easily replace it with an arbitrary optical filter. In addition, the optical element 711 is held by the optical element holder 713, the optical element engagement wall 714, and the optical element engagement protrusion portions 715, so that the optical element 711 can be prevented from jumping out of the lens mount 102 and getting damaged.

### Second Embodiment

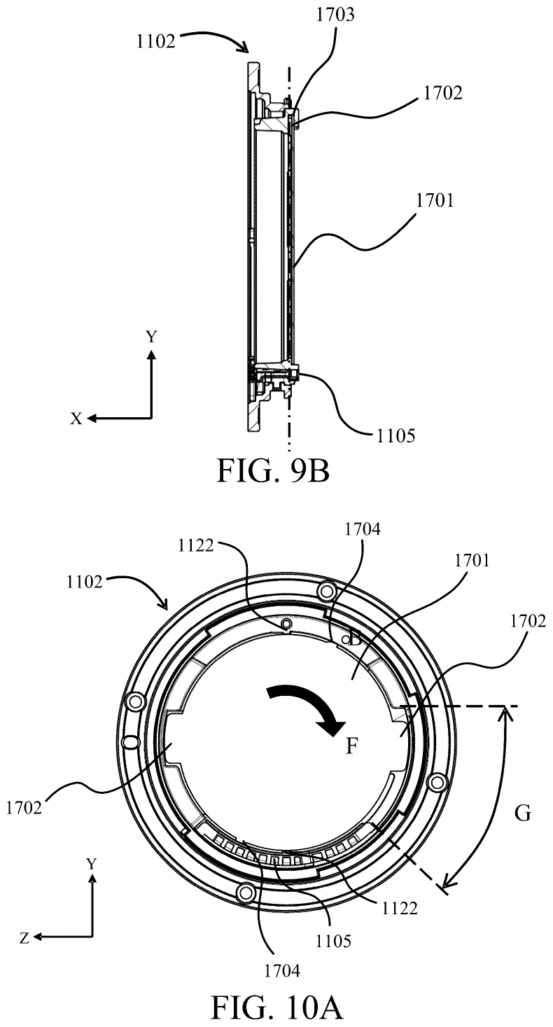

Referring now to FIGS. 9A and 9B, a description will be given of a structure for holding an optical element unit 1701 to a lens mount 1102 according to a second embodiment. FIG. 9A is a rear view of the lens mount 1102. FIG. 9B is a sectional view taken along line E-E including the optical axis OA in FIG. 9A. FIGS. 9A and 9B each illustrate an engagement state between the lens mount 1102 and the optical element unit 1701.

The optical element unit 1701 is a sheet-shaped optical filter that transmits light, and includes two optical element bayonet claws (third bayonet claw portions) 1702 on the outer circumference for holding it to the lens mount 1102. The two optical element bayonet claws 1702 are arranged at positions facing each other across the optical axis OA (positions rotated by 180° about the optical axis OA). The position of the optical element unit 1701 in the optical axis direction is determined by the optical element bayonet claws 1702 clamped in a bayonet groove portions 1703 provided to the lens mount 1102. Thereby, the optical element unit 1701 can be stably held in the lens mount 1102 at the positions facing each other across the optical axis OA.

Due to the engagement between the tip of a first protrusion 1704 provided to the optical element unit 1701 and the inner circumferential surface of the lens mount 1102, the position of the optical element unit 1701 can be determined with high accuracy relative to the optical axis OA of the interchangeable lens 1101. Due to the contact between the side portion of the first protrusion 1704 and the side portion of the second protrusion 1122 provided to the lens mount 1102, the optical element unit 1701 is prevented from rotating about the optical axis OA. Thereby, the optical element unit 1701 is less likely to accidentally fall off due to external forces such as shock or vibration.

A description will now be given of a positional relationship between the lens terminal portions (second terminal portions) 1105 and the optical element bayonet claws 1702. When viewed from the back, the lens terminal portions 1105 are arranged in an arc shape along the inner diameter side of the lens bayonet claws 1121, so that the size of the opening in the lens mount 1102 can be increased.

On the other hand, in order to increase the size of the opening in the optical element unit 1701, the optical element bayonet claws 1702 are to be separated from the optical axis OA as far as possible. Thus, the optical element bayonet claws 1702 are arranged on the same circumference as the lens terminal portions 1105 with the optical axis OA as a center at a phase (at different positions in the circumferential direction) in which the optical element bayonet claws 1702 do not overlap the lens terminal portions 1105. Thereby, the size of the opening in the optical element unit 1701 can be increased.

When viewed from the section (XY plane) as illustrated in FIG. 9A, the lens terminal portions 1105 are disposed at the rear end (−X direction) of the lens mount 1102 to be connected to the camera terminals 21. On the other hand, the optical element unit 1701 is disposed at the rear end (−X direction) so as to overlap the lens mount 1102 in the X direction. Thereby, the fifth fixed lens 631 can be brought closer to the image plane, and the back focus can be reduced.

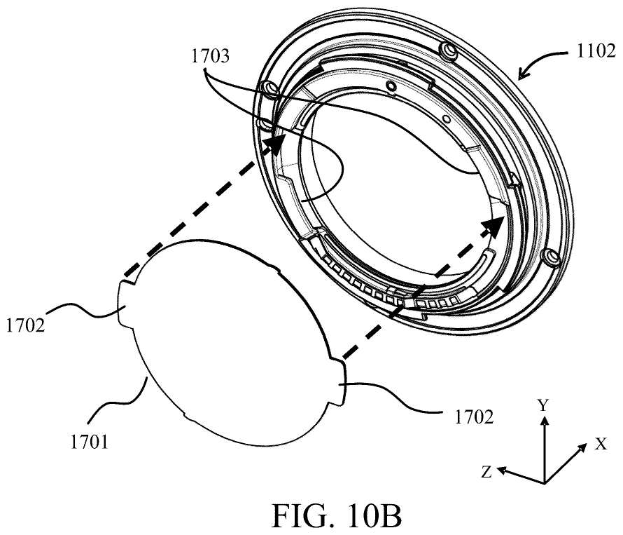

Referring now to FIGS. 10A and 10B, a description will be given of the configuration of the attachment/detachment mechanism of the optical element unit 1701. FIG. 10A is a rear view of the lens mount 1102. FIG. 10B is a perspective view (rear perspective view) of the lens mount 1102. Each of FIGS. 10A and 10B illustrates the optical element unit 1701 in a disengagement state.

In attaching or detaching the optical element unit 1701 from the lens mount 1102, a tool such as tweezers is used to separate the contact portion between the side portion of the first protrusion 1704 and the side portion of the second protrusion 1122. In this state, by rotating in the direction of arrow F in FIG. 10A, the engagement between the optical element bayonet claws 1702 and the bayonet groove portions 1703 can be released.

An area G in FIG. 10A will now be described. As described above, in attaching and detaching the interchangeable lens 101 to and from the camera body 1, the interchangeable lens 101 is rotated. The area G is an area where the interchangeable lens 101 rotates and the camera terminals 21 enter the lens mount 1102, and the lens mount 1102 is shifted in the +X direction to a height where the lens mount 1102 does not contact the tip of the camera terminals 21. Thus, the bayonet groove portions 1703 cannot be disposed in the area G.

Accordingly, this embodiment places the bayonet groove portions 1703 adjacent to the area G in the circumferential direction, so that the area where the optical element bayonet claws 1702 retract in a case where the optical element unit 1701 is attached or detached overlaps the area G. Thereby, the optical element unit 1701 can be easily attached and detached, and can be reliably fixed as a result of the attachment. Since the attachment/detachment mechanism can be efficiently disposed, the size of the opening in the lens mount 1102 can increased. Moreover, in a case where the optical element unit 1701 is detached, unnecessary light on the imaging surface caused by reflection or diffusion of incident light can be suppressed.

Each embodiment provides the lens mount with a space-saving holding mechanism that allows the optical filter to be attached and detached, reduces the back focus, and expands the effective range of the optical filter. Therefore, optical performance can be improved. Since the size of the opening in the lens mount can be increased during non-use of the optical filter, unnecessary light on the imaging surface caused by reflection or diffusion of incident light by the holding mechanism can be suppressed. The optical filter can be easily attached and detached by the user while the optical filter can be firmly held. Therefore, each embodiment can provide a lens apparatus and an imaging system that have high optical performance and stably hold an optical element.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide a lens apparatus that has high optical performance and stably holds an optical element.

This application claims priority to Japanese Patent Application No. 2024-016999, which was filed on Feb. 7, 2024, and which is hereby incorporated by reference herein in its entirety.

What is claimed is:

1. A lens apparatus comprising:
a lens mount attachable to and detachable from an image pickup apparatus having a first bayonet claw and a first terminal portion,
wherein the lens mount includes:
a second bayonet claw portion engageable with the first bayonet claw of the image pickup apparatus;
a second terminal portion that contacts the first terminal portion of the image pickup apparatus in a case where the lens apparatus is attached to the image pickup apparatus; and
a bayonet groove portion configured to detachably attach an optical element unit, and
wherein the bayonet groove portion and the second terminal portion are disposed on a predetermined circumference with an optical axis of the lens apparatus as a center.

2. The lens apparatus according to claim 1, wherein when viewed from a direction orthogonal to the optical axis, at least a part of the bayonet groove portion and at least a part of the second terminal portion are arranged so as to overlap each other on the predetermined circumference.

3. The lens apparatus according to claim 1, wherein when viewed from an optical axis direction, the bayonet groove portion and the second terminal portion are disposed at different positions on the predetermined circumference.

4. The lens apparatus according to claim 1, wherein the optical element unit is attached to and detachable from the lens apparatus by engaging the bayonet groove portion of the lens apparatus with a third bayonet claw portion of the optical element unit.

5. The lens apparatus according to claim 4, wherein the optical element unit includes:
an optical element; and
a holding frame having the third bayonet claw portion.

6. The lens apparatus according to claim 5, wherein the holding frame holds the optical element outside an effective range of the optical element through which a light ray transmits.

7. The lens apparatus according to claim 4, wherein at least a part of a first area to which the first terminal portion moves in a case where the lens apparatus is detached from the image pickup apparatus and at least a part of a second area to which the third bayonet claw portion moves in a case where the optical element unit is detached from the lens apparatus are common to each other.

8. The lens apparatus according to claim 1, wherein there are a plurality of bayonet groove portions and at least two of the plurality of bayonet groove portions are disposed at positions facing each other across the optical axis.

9. The lens apparatus according to claim 1, wherein the optical element unit includes a first protrusion portion, and the lens mount further includes a second protrusion portion that contacts the first protrusion portion of the optical element unit, and
wherein due to a contact between the first protrusion portion and the second protrusion portion, the optical element unit is restricted from rotating about the optical axis relative to the lens mount.

10. An imaging system comprising:
an image pickup apparatus; and
a lens apparatus,
wherein the lens apparatus includes:
a lens mount attachable to and detachable from an image pickup apparatus having a first bayonet claw and a first terminal portion,
wherein the lens mount includes:
a second bayonet claw portion engageable with the first bayonet claw of the image pickup apparatus;
a second terminal portion that contacts the first terminal portion of the image pickup apparatus in a case where the lens apparatus is attached to the image pickup apparatus; and
a bayonet groove portion configured to detachably attach an optical element unit, and
wherein the bayonet groove portion and the second terminal portion are disposed on a predetermined circumference with an optical axis of the lens apparatus as a center.
